(19) United States
(12) Patent Application Publication
(10) Pub. No.: US 2024/0248738 A1
(43) Pub. Date: Jul. 25, 2024

(54) SYSTEMS AND METHODS FOR CONTAINERIZING APPLICATIONS FOR DIFFERENT OPERATING SYSTEMS

(71) Applicant: VMWARE, INC., Palo Alto, CA (US)

(72) Inventor: AMAN KUMAR SINGH, Bangalore (IN)

(21) Appl. No.: 18/131,390

(22) Filed: Apr. 6, 2023

(30) Foreign Application Priority Data
Jan. 19, 2023 (IN) 202341003787

(51) Int. Cl. G06F 9/455

(52) U.S. Cl. CPC G06F 9/45558; G06F 2009/4557

(57) ABSTRACT

Systems and methods for containerization of an application, by an application transformer running a first operating system, to run on a second operating system, include gathering, by the application transformer running the first operating system, process artifacts of the application running on a first machine running the second operating system, sending, to a builder machine running the second operating system, the process artifacts of the application, and building, by the builder machine, a container image corresponding to the application based on the process artifacts, the container image being configured to run on the second operating system.

### RELATED APPLICATIONS

Benefit is claimed under 35 U.S.C. 119(a)-(d) to Foreign Application Serial No. 202341003787 filed in India entitled “SYSTEMS AND METHODS FOR CONTAINERIZING APPLICATIONS FOR DIFFERENT OPERATING SYSTEMS”, on Jan. 19, 2023, by VMware, Inc., which is herein incorporated in its entirety by reference for all purposes.

### BACKGROUND

Modern applications are applications designed to take advantage of the benefits of modern computing platforms and infrastructure. For example, modern applications can be deployed in a data center, or a multi-cloud or hybrid cloud fashion, such as, consuming both cloud services executing in a public cloud and local services executing in a private data center (e.g., a private cloud). Within the public cloud or private data center, modern applications can be deployed onto one or more virtual machines (VMs), containers, application services, and/or other virtual computing instances (VCIs).

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods.

Containerized workloads may run in conjunction with a container orchestration platform that enables the automation of much of the operational effort required to run containers having workloads and services. This operational effort includes a wide range of things needed to manage a container's lifecycle, including, but not limited to, provisioning, deployment, scaling (up and down), networking, and load balancing. Kubernetes® (K8S)® software is an example open-source container orchestration platform that automates the operation of such containerized workloads.

In some cases, it may be desirable to containerize a non-containerized application. Containerization refers to the process of packaging software code, its required dependencies, configuration, and other details as container images that can be instantiated in computing environments, such as on hosts or VMs. However, applications containerized on and for a first operating system are generally not able to run on a second operating system different from the first operating system. Accordingly, having a more streamlined approach for containerization of applications for different operating systems may be necessary.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for containerization of an application, by an application transformer running a first operating system, to run on a second operating system. The method generally includes gathering, by the application transformer running the first operating system, process artifacts of the application running on a first machine running the second operating system, sending, to a builder machine running the second operating system, the process artifacts of the application, and building, by the builder machine, a container image corresponding to the application based on the process artifacts, the container image being configured to run on the second operating system.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates a computing system in which embodiments described herein may be implemented, according to aspects of the present disclosure.

FIG. 2 illustrates a block diagram of example components for containerizing applications for different operating systems, according to aspects of the present disclosure.

FIG. 3 is a flow diagram illustrating example operations for containerizing applications for different operating systems, according to aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides techniques for containerization of applications for different operating systems.

In certain aspects, an application transformer is a physical machine, VM, or other VCI running a first operating system (e.g., Linux). Application Transformer for VMware Tanzu is an example of an application transformer. Accordingly, the application transformer may be capable of directly taking non-containerized applications built to run on the first operating system and generating a container image that can be used to instantiate containers on the first operating system. However, the application transformer running the first operating system is not capable of directly taking non-containerized applications built to run on a second operating system (e.g., Windows) and generating a container image that can be used to instantiate containers on the second operating system. Accordingly, aspects herein provide techniques to allow an application transformer running a first operating system to generate containerized applications for running on a second operating system.

In certain aspects, the techniques include the application transformer gathering information regarding an application running on the second operating system. For example, the application may be running on a first VM running the second operating system.

The application transformer may install an agent for the application transformer on the first VM. The agent is configured to gather raw process data from the first VM, and identify components of processes running on the first VM. For example, the agent gathers such raw process data to discover applications running on the first VM, such that a user can select an application to be containerized.

A process refers to an instance of a computer program. For example, a process includes a portion of computer memory (e.g., virtual memory of the first VM) which is occupied by the computer program's executable code. In certain aspects, the process further includes a data structure maintained by the operating system (e.g., second operating system of the first VM) on which the process runs. The data structure may include information such as a running state of the process, scheduling state of the process, memory management information, open file descriptors held by the process, and/or the like.

A component is a representation of a running process on a computer, such as the first VM. For example, the component includes attributes of the process running on the first VM. The attributes, for example, include one or more of 1) a subset of static identification attributes (e.g., name of the process, full path of the executable of the process in storage, version of the executable, command line parameters used to start the process, a working directory of the process, environment variables, start time of the process, owner user of the process, and/or the like); or 2) a subset of the current state of the process (e.g., list of open socket file descriptors, list of open disk files, and/or the like). A component may have a one-to-one relationship with a running process. An environment variable is a dynamic-named value that can affect the way running processes behave on a computer and are part of the environment in which the process runs.

The agent may present, such as in a graphical user interface (GUI) the identified components and/or processes running on the first VM. For example, the agent may generate a JSON containing a list of processes and their components. A user selects one or more components and/or processes to be containerized as an application. For example, a user can group multiple (e.g., related and inter-communicating) processes together to form an application. Accordingly, an application includes one or more components, communication between the components, and services supporting the components. In certain aspects, the components are identified by the user using a component signature, which is a set of static identification attributes of a process that can be used to classify it. For example, the component signature includes a regular expression containing process name and executable-path, and a regular expression encoding an expected patter in the process's command line arguments.

Accordingly, the agent gathers a relevant set of process artifacts associated with the application (i.e., associated with the one or more processes/components) running in the first VM. In certain aspects, process artifacts may include one or more files (also referred to as process files) associated with execution of the application, such as executable files, tarball files, or combinations thereof associated with the application. In certain aspects, tarball files include a set of files packaged together into a single file, such as based on a Unix command referred to as Tar that creates the single file. In certain aspects, the process artifacts may include one or more of dynamic link libraries (DLLs), configuration files, assets, etc., associated with the application.

The agent running on the first VM running the second operating system then transfers the set of process artifacts of the application to the application transformer running the first operating system. In order to create a containerized application compatible with the second operating system, the application transformer is configured to send the process artifacts to a second VM running the second operating system. The second VM may be referred to as a builder VM, and configured to create a containerized application compatible with the second operating system. In certain aspects, the second VM runs the second operating system with CPU hardware virtualization enabled (e.g., Hyper-V enabled), includes a container engine (e.g., Docker engine), and can communicate over a network with the application transformer. Enabling CPU hardware virtualization, in certain aspects, allows the second VM to run the container engine to build container images.

In particular, the container engine running on the second VM generates a container image using the process artifacts, wherein the container image can be used to instantiate containers on the second operating system.

In certain aspects, more specifically the application transformer retrieves a base container image (e.g., base Docker image, such as a base Dockerfile) compatible with the second operating system, creates a build context of the container build using the process artifacts, and then transfer the base container image, build context, and process artifacts to the second VM, whereby the second VM then builds the container image.

In certain aspects, the first VM and the second VM run in the same data center, or even the same host. Further, in certain aspects, the application transformer runs in the same data center as the first VM and the second VM, or even the same host. Accordingly, the techniques herein allow for an application to be containerized locally for different operating systems within a same data center or even host, thereby reducing the risk of sending application code to a third party.

It should be noted that though certain aspects are discussed using Docker or Kubernetes as an example, the techniques discussed herein may be similarly applicable to other suitable container orchestration platforms. Further, though certain techniques are discussed with respect to containerizing workloads on the operating systems of VMs as an example, it should be noted that such techniques are similarly applicable to containerizing workloads on the operating systems of physical machines as well.

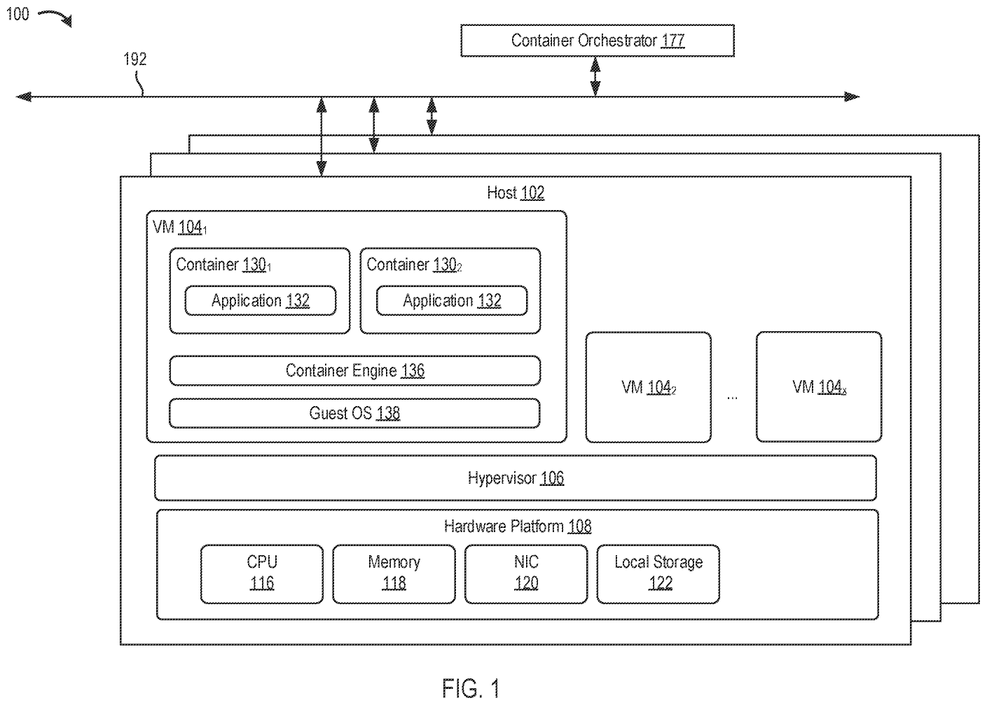

FIG. 1 is a block diagram that illustrates a computing system 100 (also referable to as a computer system 100) in which embodiments described herein may be implemented. Computing system 100 includes one or more hosts 102 connected by a physical network 192. In particular, physical network 192 enables communication between hosts 102, and/or between other components and hosts 102. In certain aspects, computing system 100 resides in a data center.

Hosts 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 104₁ to 104_{N} (collectively referred to as VMs 104 and individually referred to as VM 104) that run concurrently on the same host 102.

Hardware platform 108 of each host 102 includes components of a computing device such as one or more processors (central processing units (CPUs)) 116, memory 118, a network interface card including one or more network adapters, also referred to as NICs 120, and/or storage 122. CPU 116 is configured to execute instructions that may be stored in memory 118 and in storage 122. The computing components described herein are understood to be communicatively coupled.

In certain aspects, hypervisor 106 may run in conjunction with an operating system (not shown) in host 102. In some embodiments, hypervisor 106 can be installed as system level software directly on hardware platform 108 of host 102 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 106 implements one or more logical entities, such as logical switches, routers, etc. as one or more virtual entities such as virtual switches, routers, etc. In some implementations, hypervisor 106 may comprise system level software as well as a “Domain 0” or “Root Partition” virtual machine (not shown), which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Each VM 104 implements a virtual hardware platform that supports the installation of a guest OS 138 which is capable of executing one or more applications. Guest OS 138 may be a standard, commodity operating system. Examples of types of a guest OS include Microsoft Windows, Linux, and/or the like. Different VMs 104 may include different operating systems.

In certain embodiments, each VM 104 includes a container engine 136 as a runtime engine installed therein and running as a guest application under control of guest OS 138. In embodiments, the runtime engine may be a Docker engine. Container engine 136 is a process that enables the deployment and management of virtual instances (referred to interchangeably herein as “containers”) by providing a layer of OS-level virtualization on guest OS 138 within VM 104. Containers 130₁ to 130_{Y} (collectively referred to as containers 130 and individually referred to as container 130) are software instances that enable virtualization at the OS level. That is, with containerization, the kernel of guest OS 138, or an OS of host 102 if the containers are directly deployed on the OS of host 102, is configured to provide multiple isolated user space instances, referred to as containers. Containers 130 or groups of containers referred to as pods appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132 as a single executable package of software that bundles application code together with all of the related configuration files, libraries, and dependencies required for it to run. Application 132 may be any software program, such as a word processing program.

In certain embodiments, computing system 100 can include a container orchestrator 177. Container orchestrator 177 implements an orchestration control plane, such as Kubernetes®, to deploy and manage applications and/or services thereof on hosts 102, of a host cluster, using containers 130. For example, Kubernetes may deploy containerized applications as containers 130 and a control plane on a cluster of hosts. The control plane, for each cluster of hosts, manages the computation, storage, and memory resources to run containers 130. Further, the control plane may support the deployment and management of applications (or services) on the cluster using containers 130. In some cases, the control plane deploys applications as pods of containers running on hosts 102, either within VMs or directly on an OS of the host.

Application modernization relates to updating older software for newer computing platforms and approaches, including, but not limited to, new computing programming languages and infrastructure platforms. The process of packaging software code, required dependencies, configurations, and other details as container images for deployment in the same or other computing environment is referred to as containerization. Containerization involves modernizing applications to run on containers. In some examples, the modernized application are Cloud Native Computing Foundation (CNCF) compliant, which is an open-source, vendor neutral hub of cloud native computing that host projects such as Kubernetes. Containerization generally involves collecting relevant process runtime information, which may be referred to herein as process artifacts, and using the collected information to build a container image. The container image may be uploaded to an image registry for use in deployments. Additional details of modernization and containerization are disclosed in U.S. application Ser. No. 17/513,925, filed on Oct. 29, 2021, and titled “CUSTOM METADATA COLLECTION FOR APPLICATION COMPONENTS IN A VIRTUALIZED COMPUTING SYSTEM,” which is hereby incorporated by reference herein in its entirety.

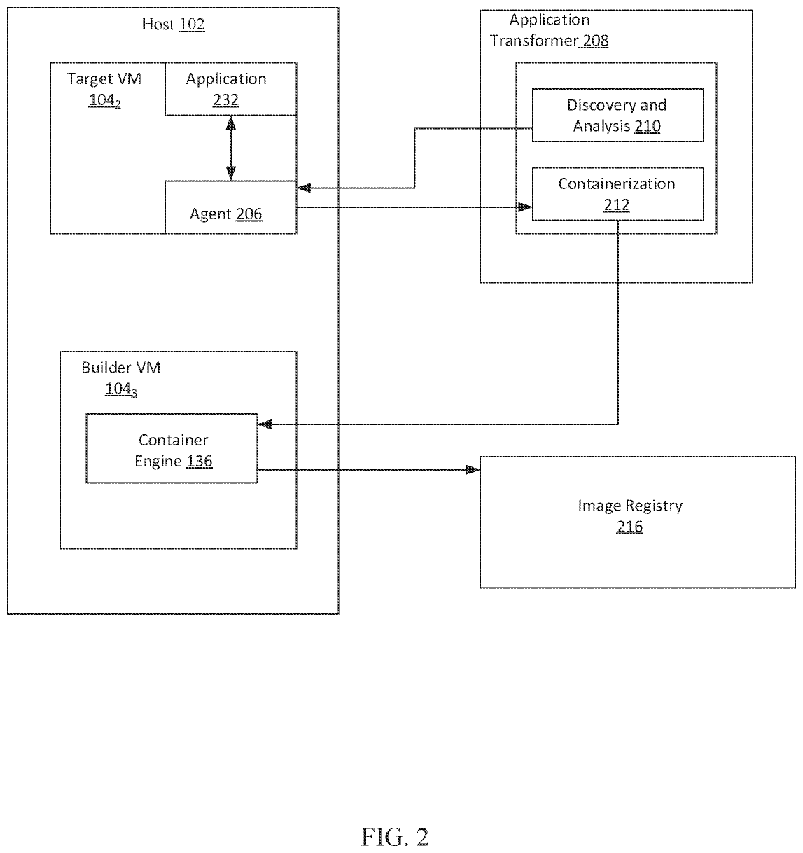

FIG. 2 depicts example components of computer system 100 used for containerizing workloads for different operating systems. In particular, FIG. 2 illustrates a target VM 104₂ running an application 232 and an agent 206. The target VM 104₂ may run a second operating system, which in an example is a Windows operating system. As shown, target VM 104₂ is running on host 102. In certain aspects, the application 232 is a non-containerized application to be containerized to run on the second operating system. The agent 206 is a local agent of application transformer 208, as discussed herein.

Application transformer 208 may be a physical machine, VM, or other VCI. For example, application transformer 208 may be a host 102 or a VM 104 in computing system 100. In certain aspects, application transformer 208 is part of container orchestrator 177. In certain aspects, application transformer 208 runs a first operating system, which in an example is Linux. Application transformer 208 is configured to convert a non-containerized application into a containerized application. For example, application transformer is configured to convert a non-containerized application running in a VM, to a containerized application, such as by generating a container image corresponding to the containerized application. The container image can be used to instantiate a container on, for example, a VM or a host machine.

Application transformer 208 includes a discovery and analysis module 210 and a containerization module 212. The modules may be computer programs or processes running on application transformer 208. In certain aspects, the discovery and analysis module 210 is configured to discover a set of processes and/or components running on target VM 104₂. For example, discovery and analysis module 210 works with agent 206 to discover a set of processes and/or components running on target VM 104₂ and presents a list of processes and/or components to a user for selection as an application to containerize, as discussed. Further, discovery and analysis module 210 is configured to work with agent 206 to gather process artifacts for the selected application running on VM 104₂.

In certain aspects, the containerization module 212 is capable of directly containerizing applications to run on the same first operating system as the application transformer 208 runs. However, in certain aspects, containerization module 212 is not configured to directly containerize applications to run on a different operating system, such as the second operating system.

Accordingly, in certain aspects, containerization module 212 is configured to work with a builder VM 104₃ to containerize applications to run on the second operating system. Builder VM 104₃, as shown, runs on the same host 102 as target VM 104₂. However, it should be understood that in other embodiments, builder VM 104₃ may run on a different host than target VM 104₂ within the same data center, or even in another data center.

In certain aspects, containerization module 212 is configured to send process artifacts for the selected application, and optionally a base container image and build context. Builder VM 104₃ is configured to use the process artifacts (and optionally base container image and build context it gets from containerization module 212 or from another source, such as a container hub) to build a container image corresponding to the selected application that can be used to instantiate containers on a host or VM running the second operating system. For example, builder VM 104₃ includes container engine 136, that can build a container image. In certain aspects, the container image is stored in an image registry 216, which may be a database within computing system 100, or on another network or data center.

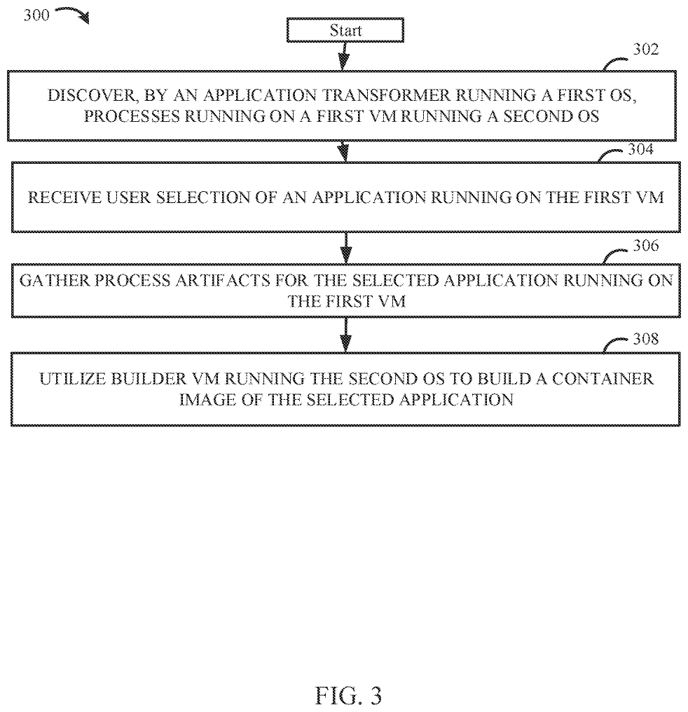

By way of example, and not as a limitation, FIG. 3 illustrates example operations as a method 300 for containerization of applications for different operating systems as described herein. At block 302, components and/or processes running on a first VM running a second operating system are discovered by an application transformer running a first operating system. For example, discovery and analysis module 210 works with agent 206 to discover components and/or processes running on target VM 104₂. In certain embodiments, discovery and analysis module 210 generates a parse and script command and causes agent 206 to execute the command on the second operating system running on VM 104₂ to discover processes and/or components running on target VM 104₂. In an example, the parse and script command comprises a PSinfo command to gather key information about the Windows processes may be executed and then parsed.

At block 304, the user selects an application running on the first VM to be containerized. For example, the user selects one or more of the discovered processes and/or components running on target VM 104₂ as an application.

At block 306, the application transformer gathers process artifacts for the selected application. For example, agent 206 gathers process artifacts for the selected application running on target VM 104₂ and sends them to application transformer 208.

At block 308, the application transformer utilizes a builder VM running the second operating system to build a container image targeted at the second operating system. For example, as discussed, application transformer 208 sends process artifacts for the selected application, and optionally a base container image and build context to the builder VM 104₃. The builder VM 104₃ uses the process artifacts to build the container image.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the disclosure may be useful machine operations. In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for containerization of an application, by an application transformer running a first operating system, to run on a second operating system, the method comprising:
gathering, by the application transformer running the first operating system, process artifacts of the application running on a first machine running the second operating system;
sending, to a builder machine running the second operating system, the process artifacts of the application; and
building, by the builder machine, a container image corresponding to the application based on the process artifacts, the container image being configured to run on the second operating system.

2. The method of claim 1, wherein the first machine comprises a first virtual machine (VM), and the builder machine comprises a second VM.

3. The method of claim 1, wherein the first operating system is Linux, the second operating system is Windows, and the builder machine has CPU hardware virtualization enabled.

4. The method of claim 1, wherein the builder machine runs a container engine, and wherein building the container image is performed by the container engine.

5. The method of claim 1, further comprising:
discovering a plurality of components of a plurality of processes running on the first machine; and
receiving a selection of one or more of the plurality of components as the application.

6. The method of claim 1, wherein building the container image is further based on a base container image associated with the second operating system.

7. The method of claim 1, wherein the first machine, the builder machine, and the application transformer are in a same data center.

8. A non-transitory computer readable medium comprising instructions that, when executed by one or more processors of a computing system, cause the computing system to perform operations for containerization of an application, by an application transformer running a first operating system, to run on a second operating system, the operations comprising:
gathering, by the application transformer running the first operating system, process artifacts of the application running on a first machine running the second operating system;
sending, to a builder machine running the second operating system, the process artifacts of the application; and
building, by the builder machine, a container image corresponding to the application based on the process artifacts, the container image being configured to run on the second operating system.

9. The non-transitory computer readable medium of claim 8, wherein the first machine comprises a first virtual machine (VM), and the builder machine comprises a second VM.

10. The non-transitory computer readable medium of claim 8, wherein the first operating system is Linux, the second operating system is Windows, and the builder machine has CPU hardware virtualization enabled.

11. The non-transitory computer readable medium of claim 8, wherein the builder machine runs a container engine, and wherein building the container image is performed by the container engine.

12. The non-transitory computer readable medium of claim 8, wherein the operations further comprise:
discovering a plurality of components of a plurality of processes running on the first machine; and
receiving a selection of one or more of the plurality of components as the application.

13. The non-transitory computer readable medium of claim 8, wherein building the container image is further based on a base container image associated with the second operating system.

14. The non-transitory computer readable medium of claim 8, wherein the first machine, the builder machine, and the application transformer are in a same data center.

15. A computer system for containerization of an application, by an application transformer running a first operating system, to run on a second operating system, the computer system comprising:
a memory; and
at least one processor communicatively coupled to the memory, the at least one processor being configured to:
gather, by the application transformer running the first operating system, process artifacts of the application running on a first machine running the second operating system;
send, to a builder machine running the second operating system, the process artifacts of the application; and
build, by the builder machine, a container image corresponding to the application based on the process artifacts, the container image being configured to run on the second operating system.

16. The computing system of claim 15, wherein the first machine comprises a first virtual machine (VM), the builder machine comprises a second VM, the builder machine runs a container engine, and building the container image is performed by the container engine.

17. The computing system of claim 15, wherein the first operating system is Linux, the second operating system is Windows, and the builder machine has CPU hardware virtualization enabled.

18. The computing system of claim 15, wherein the at least one processor is further configured to:
discover a plurality of components of a plurality of processes running on the first machine; and
receive a selection of one or more of the plurality of components as the application.

19. The computing system of claim 15, wherein building the container image is further based on a base container image associated with the second operating system.

20. The computing system of claim 15, wherein the first machine, the builder machine, and the application transformer are in a same data center.
